(19) United States
(12) Patent Application Publication
(10) Pub. No.: US 2004/0005263 A1
(43) Pub. Date: Jan. 8, 2004

(54) Process for reducing NOx in waste gas streams using sodium chlorite

(75) Inventors: Theresa J. Takacs, Alexandria, VA (US); Robert G. Balmer, Glen Gardner, NJ (US); John D. Cunic, Denville, NJ (US); Henry Shaw, Scotch Plains, NJ (US); Chen-Lu Yang, Millburn, NJ (US); Pin Gu, Belleville, NJ (US)

Correspondence Address: EXXONMOBIL RESEARCH AND ENGINEERING COMPANY, P.O. BOX 900, 1545 ROUTE 22 EAST, ANNANDALE, NJ, 08801-0900, US

(73) Assignee: ExxonMobil Research and Engineering Company, Annandale, NJ

(21) Appl. No.: 10/427,266

(22) Filed: May 1, 2003

Related U.S. Application Data
(60) Provisional application No. 60/386,560, filed on Jun. 5, 2002.
(60) Provisional application No. 60/386,492, filed on Jun. 5, 2002.
(60) Provisional application No. 60/442,268, filed on Jan. 24, 2003.

(51) Int. Cl. B01D 53/60

(52) U.S. Cl. 423/239.1; 423/243.01

(57) ABSTRACT

A process for reducing NOₓ concentrations in waste gas streams. More particularly, the present invention relates to contacting a NOₓ-containing waste gas stream with an effective amount of sodium chlorite under conditions such that at least a fraction of the oxidizable NOₓ species present in the waste gas stream is oxidized to higher nitrogen oxides.

### CROSS-REFERENCE TO RELATED APPLICATIONS

This application claims benefit of the following United States Provisional Patent Applications: Serial No. 60/386,560 filed Jun. 5, 2002; Serial No. 60/386,492 filed Jun. 5, 2002; and Serial No. 60/442,268 filed Jan. 24, 2003.

### FIELD OF THE INVENTION

The present invention relates to a process for reducing NOₓ concentrations in waste gas streams. More particularly, the present invention relates to contacting a NOₓ-containing waste gas stream with an effective amount of sodium chlorite under conditions such that at least a fraction of the oxidizable NOₓ species present in the waste gas stream is oxidized to higher nitrogen oxides.

### BACKGROUND OF THE INVENTION

Increasingly stringent government regulatory emission standards have led refiners to explore improved technologies for reducing the concentration of nitrogen oxides (“NOₓ”) in emissions from combustion and production effluent or waste gas streams. For example, the technology taught in U.S. Pat. No. 3,957,949 to Senjo, et al., which is incorporated herein by reference teaches a method for removing low-soluble pollutants, such as mercury and NO, from waste gas streams by use of an oxidizing agent that is released from a compound, such as sodium chlorite, that is injected into a recycle stream. Also, U.S. Pat. No. 6,294,139 to Vicard et al., which is also incorporated herein by reference, discloses a method for removing nitrogen oxides from waste gas streams by oxidizing nitrogen oxide with chlorine dioxide or ozone, then bringing the oxidized gas in contact with sodium chlorite in a water solution. Further, it is known in the art to reduce NOₓ concentrations in combustion effluent streams by the injection of ammonia, see U.S. Pat. No. 3,900,554 to Lyon, which is also incorporated herein by reference. After the Lyon patent, there was a proliferation of patents and publications relating to the injection of ammonia into combustion streams in order to reduce NOₓ concentration. Such patents include U.S. Pat. Nos. 4,507,269 and 4,115,515, both of which are incorporated herein by reference.

Even so, effluents released from combustion units and production streams, such as the regenerator off-gas of a fluidized catalytic cracking (“FCC”) unit, remain a source of NOₓ emissions from refineries. Many fluidized catalytic cracking process units incorporate wet gas scrubbers to remove attrited catalyst fines, with the ancillary benefit of these wet gas scrubbers reducing NO₂. While scrubbing is effective for reducing NO₂ emissions, it is not as effective for reducing NO emissions. Since a majority (typically about 90%) of the NOₓ contained on FCC unit's waste gas streams is NO, there is a need for a method for reducing NO emissions from an FCC unit's waste gas (or “offgas”) in order to obtain further reductions in total NOₓ emissions.

One approach to reducing NO emissions involves oxidizing lower oxide NOₓ species to higher nitrogen oxides. However, the conventional methods involve either chemicals that require extended reaction periods or they create problems within the processing unit. Such problems include, for example, corrosion of materials of construction, problems with treating the waste water from the unit, as well as problems relating to the removal of SOₓ species that are typically also present. For example, it is known in the art to add sodium chlorite (NaClO₂) to the wet gas scrubber liquor to oxidize NOₓ species to higher oxides such as, for example, to NO₂ and N₂O₅ which are water soluble and which can be removed from the process system, typically as nitrate and nitrite, respectively.

However, the addition of sodium chlorite to the scrubber liquor has disadvantages. For example, sodium chlorite is a costly chemical and can be consumed by side reactions, such as the oxidation of SOₓ species to higher sulfur oxides (e.g., SO₂ to SO₃). Thus, because sodium chlorite does not selectively oxidize lower oxide NOₓ species to higher nitrogen oxides, conventional methods require the use of relatively high sodium chlorite concentrations in the scrubber liquor to achieve the desired reduction of oxidizable NOₓ species. These high levels of sodium chlorite lead to high chloride levels that cause, among other things, corrosion of the scrubber's materials of construction.

Thus, there still is a need in the art for an economical and effective method to reduce the level of NOₓ species from waste gas streams.

### SUMMARY OF THE INVENTION

In accordance with the present invention, there is provided a process for reducing NOₓ concentrations in waste gas streams, which streams contain both NOₓ and SOₓ species, which process comprises:

a) removing at least a fraction of the SOₓ species from said waste gas stream thereby producing an SOₓ depleted waste gas stream;

b) contacting said SOₓ depleted waste gas stream with an effective amount of sodium chlorite at effective oxidation conditions that will oxidize at least a fraction of oxidizable NOₓ species to higher nitrogen oxides; and

c) removing at least a fraction of said higher nitrogen oxides from the treated waste gas stream.

In a preferred embodiment spray nozzles integral to a wet gas scrubber separator drum are used to contact the sodium chlorite with the waste gas stream.

In another preferred embodiment, the resulting higher nitrogen oxides of the NOₓ species are removed from the waste gas stream by a method selected from the group consisting of alkaline solution absorption, reducing solution absorption, scrubbing, ammonia injection, catalytic conversion, and absorption with water.

In still another preferred embodiment at least a fraction of the NOₓ species initially present in the waste gas stream is removed before step a) above.

### DETAILED DESCRIPTION OF THE PRESENT INVENTION

As used herein, the terms NOₓ, NOₓ species, and nitrogen oxides refers to the various oxides of nitrogen that may be present in combustion waste gasses. Thus, the terms refer to all of the various oxides of nitrogen including, but not limited to, nitric oxide (NO), nitrogen dioxide (NO₂), nitrogen peroxide (N₂O₄), nitrogen pentoxide (N₂O₅), and mixtures thereof. Also, the term “lower nitrogen oxide” refers to nitrogen oxides that are oxidizable to higher oxides. Nitric oxide (NO) is the most preferred nitrogen oxide to be oxidized since up to about 90 wt. % of the nitrogen oxides in a typical FCC unit's waste gas stream treated by the present invention is NO. Therefore, in one embodiment, the process is especially concerned with the reduction and control of NO.

The terms flue gas, wet gas, combustion effluent stream, combustion waste gas effluent stream, waste gas, offgas, and waste gas stream are used interchangeably herein. Also, the terms wet gas scrubber, scrubbing apparatus, and scrubber are also sometimes used interchangeably herein.

The present invention provides a cost effective manner for removing NOₓ species from waste gas streams produced by combustion units, such as, for example, the waste gas generated by a fluidized catalytic cracking process unit. The instant process involves adding an effective amount of sodium chlorite to the waste gas stream under conditions effective for oxidizing at least a fraction of the lower nitrogen oxides, particularly NO, contained in the waste gas stream to higher oxides (e.g. NO₂ and higher). As used herein, an effective amount of sodium chlorite is an amount that oxidizes at least a fraction of the oxidizable NOₓ species present in the waste gas stream. By at least “a fraction” we mean at least about 20 vol. %, for example 20 vol. % to about 80 vol. %, preferably about 40 vol. % to about 90 vol. %, more preferably about 50 vol. % to about 99 vol. %, and most preferably substantially all of the lower oxide NOₓ species present in the waste gas stream are oxidized to higher nitrogen oxides.

Thus, by using sodium chlorite to oxidize the lower NOₓ species to higher oxides of nitrogen, the level of NOₓ emissions from flue gas streams can be reduced as the higher nitrogen oxides such as, for example, NO₂ and N₂O₅, are more easily removed than are lower nitrogen oxides.

As discussed, the addition of sodium chlorite to the scrubber liquor is described in U.S. Pat. No. 6,294,139. Adding sodium chlorite to the scrubber liquor is disadvantageous because sodium chlorite also oxidizes SOₓ species to higher sulfur oxides. This non-preferential oxidation reaction may lead to injecting relatively high levels of sodium chlorite into the waste gas stream in order to remove a satisfactory amount of NOₓ species present in the waste gas stream. As discussed, these high levels of sodium chlorite have the undesirable effects of causing corrosion of the scrubber hardware, causing problems associated with waste water treatment, as well as increasing the costs of reagents. Moreover, using chlorine dioxide to oxidize the NOₓ species to higher nitrogen oxides in combination with sodium chlorite absorption to remove the higher nitrogen oxides has the additional disadvantage of higher costs.

The instant invention solves at least some of these problems by contacting the waste gas stream directly with sodium chlorite downstream from an SOₓ removal step. The SOₓ removal method employed is not essential to the present invention and may be any effective method. In one embodiment, the SOₓ removal method preferably reduces the levels of SOₓ species in the waste gas stream to below about 100 ppm, preferably below about 50 ppm, and more preferably below about 10 ppm before the sodium chlorite is mixed with the waste gas stream. It is most preferred to remove substantially all of the SOₓ species present in the waste gas stream before the sodium chlorite is mixed with the waste gas stream. Non-limiting examples of SOX removal processes suitable for use herein include wet desulfurization methods such as water scrubbing, alkali scrubbing, magnesia scrubbing, and ammonium scrubbing, as well as dry desulfurization methods such as using manganese oxide or activated carbon. Preferably, the SOₓ species are removed by a wet desulfurization method, most preferably by use of a wet gas scrubber.

Wet gas scrubbers remove, for example, attrited catalyst fines and SOₓ species. Thus, by contacting the waste gas stream with the sodium chlorite after the scrubbers, there is a lower level of SOₓ species present in the waste gas stream at the point of mixing with sodium chlorite. Consequently, lesser quantities of sodium chlorite can be used to achieve the desired reduction of NOₓ species. Further, this lower use rate of sodium chlorite also mitigates the above mentioned problems, such as corrosion of hardware and waste water treatment.

While the mechanism by which sodium chlorite oxidizes oxidizable NOₓ species to higher nitrogen oxides is complex, it is believed that sodium chlorite can react directly with the NOₓ species, or under acidic conditions, preferably below a pH of about 6 herein, form chlorine dioxide. While not wishing to be bound by any theory or model, it is believed that under such acidic conditions, the sodium chlorite compound disproportionates into sodium ions and chlorine dioxide. The gaseous chlorine dioxide thus formed oxidizes lower NOₓ species to higher oxides. While not wishing to be bound, it is believed that the general oxidation reaction where chlorine dioxide oxidizes NOₓ species to higher oxides can be represented by the following equation:

5NO+3ClO₂+4H₂O→5HNO₃+3HCl. Equation 1:

When using sodium chlorite in an acidic environment, preferably below a pH of about 6, the amount of chlorine dioxide needed to oxidize lower NOₓ species to higher oxides must be considered to ensure the presence of sufficient quantities of sodium chlorite. Accordingly, when the sodium chlorite disproportionates, there should be a sufficient concentration of chlorine dioxide present to oxidize the lower NOₓ's to higher oxides. In one embodiment, the amount of chlorine dioxide used ranges from about 3 to about 8 moles of ClO₂ to about 5 moles of NO. Alternatively, the amount ranges from about 4 to about 7 moles of ClO₂ to about 5 moles of NO. Preferably a slightly greater than stoichiometric amount of sodium chlorite, for example, about 3 to about 4 moles of C10₂ to about 5 moles of NO.

As discussed, sodium chlorite can also oxidize NOₓ species directly. This oxidation can occur in a slightly acidic environment, e.g., a pH of about 6 to about 7, a neutral environment, pH of about 7, or a basic environment, pH above about 7. However, as the pH increases to about 10, the absorption of NOₓ species decreases. While not wishing to be bound, it is believed that the mechanism by which sodium chlorite reacts directly with NOₓ species can be represented by Equation 2 below.

4NO+3NaClO₂+2H₂O→4HNO₃+3NaCl. Equation 2:

When sodium chlorite oxidizes NOₓ species directly, the amount of sodium chlorite used will typically range from about 3 to about 10 times the stoichiometric amount of sodium chlorite to lower oxide NOₓ species, preferably from about 2 to about 8 times the stoichiometric amount, and most preferably slightly greater than the stoichiometric amount of sodium chlorite, for example, about 1.1 to about 2.5 times the stoichiometric amount, needed to oxidize at least a fraction of the lower nitrogen oxides to higher oxides.

After at least a fraction of the oxidizable NOₓ species are oxidized to higher nitrogen oxides, at least a fraction of these higher nitrogen oxides can be removed. The removal of these higher nitrogen oxides may be accomplished by any effective process. Such processes include, but are not limited to, the use of an alkaline solution such as an aqueous caustic soda solution or a reducing solution such as an aqueous sodium thiosulfate solution, sodium chlorite absorption, catalytic conversion, and ammonia and hydrogen injection, as described in U.S. Pat. No. 3,900,554. Most preferably the oxidized NOₓ compounds are removed by scrubbing with water because the higher oxides such as, for example, NO₂ and N₂O₅ are more water soluble than are the lower nitrogen oxides. In the practice of the presently claimed invention, about 20 vol. % to about 100 vol. % of the higher oxides are removed after oxidation, preferably about 40 vol. % to about 80 vol. % of the higher oxides are removed after oxidation, more preferably about 60 vol. % to about 90 vol. % of the higher oxides of the NOₓ species are removed after oxidation.

As discussed, it is preferred that at least a fraction of the SOₓ species of the waste gas stream be removed, preferably by wet gas scrubbing. Thus, in one embodiment, sodium chlorite is mixed with the waste gas stream in an existing separator drum typically associated with the wet gas scrubber. A conventional separator drum may contain hardware such as spray nozzles located within the separator drum. In one embodiment, a contaminated waste gas stream is conducted to a separator drum and the sodium chlorite is sprayed through the spray nozzles so that the stream contacts the sodium chlorite. The sodium chlorite can be first mixed with water, preferably deionized water, which acts as a carrier fluid to better disperse the sodium chlorite. Additional amounts of deionized water may be sprayed through the spray nozzles. By additional amount of deionized water, it is meant that amount of deionized water sufficient to absorb at least a fraction of the higher nitrogen oxides.

In another embodiment, a greater amount of sodium chlorite than necessary to oxidize a given fraction of the NOₓ species present in the waste gas stream is mixed with the waste gas stream after the SOₓ removal step. This additional amount of sodium chlorite oxidizes at least a fraction of any SOₓ species remaining in the waste gas stream to higher sulfur oxides after the SOₓ removal step. These higher oxides of SOₓ species can then be removed by any effective method.

In another embodiment, the waste gas stream is passed through an initial NOₓ removal step to remove at least a fraction of the NOₓ initially present in the waste gas stream in order to reduce the amount of sodium chlorite needed to oxidize the remaining oxidizable NOₓ species in the waste gas stream. In this first NOₓ removal step, at least about 10 vol. %, preferably from about 10 vol. % to about 30 vol. %, more preferably from about 20 vol. % to about 60 vol. %, and most preferably about 30 vol. % to about 90 vol. %, of the NOₓ initially present in the waste gas stream are removed before the waste gas stream is mixed with the sodium chlorite. The manner in which an initial amount of NOₓ species is removed before the waste gas stream is mixed with sodium chlorite is not critical and may be any effective method.

The above description is directed to one preferred means for carrying out the present invention. Those skilled in the art will recognize that other means that are equally effective could be devised for carrying out the spirit of this invention.

### EXAMPLES

The following examples will illustrate the effectiveness of the present process, but is not meant to limit the present invention in any manner.

### Example 1

The addition of sodium chlorite to a waste gas stream was tested in a bench scale environment. The concentration of SOₓ species and NOₓ species present in the waste gas stream, a simulated scrubber liquor, were measured before the experiment began, and this data is shown in Table 1 below. The initial temperature of the stream was measured using a thermocouple device and was observed to be 68° F. The initial oxygen concentration of the waste gas stream was also measured and was determined to be 3.0 vol. % O₂.

The waste gas was allowed to flow through a 5 cm bench scale venturi scrubber, and sodium chlorite was added to the waste gas stream downstream from the scrubber. The pH and sodium chlorite concentration of the system, along with the outlet concentration of SOₓ species and NOₓ species, were also monitored. The experiment removed greater than 95% of the SOₓ species and greater than 90% NOₓ species initially present in the waste gas stream. All parameters, along with the results of this experiment, are reported in Table 1 below.

TABLE 1

| NOx inlet | 50-60 ppmv |
|---|---|
| SOx inlet | 50-500 ppmv |
| Waste Gas Temperature | 68° F. |
| O₂ vol. % | 3 |
| Scrubber Liquor | simulated |
| NaClO₂ concentration | 0.01-0.1 M |
| System pH | 4.05-9.10 |
| NOx outlet (% removal) | >90% |
| SOx outlet (% removal) | >95% |

### Example 2

An embodiment was also tested on a full-scale operational fluidized catalytic cracking process unit. This experiment was performed without any modifications to the existing separator drum associated with the wet gas scrubber of the fluidized catalytic cracking process unit.

In this experiment, the spray nozzles of the wet gas scrubber separator drum of the fluidized catalytic process unit were used to mix the sodium chlorite with the waste gas stream. The sodium chlorite was first mixed with deionized water and sprayed into the separator drum using the spray nozzles. An additional amount of deionized water was also used in this experiment to remove a fraction of the resulting higher nitrogen oxides by water absorption.

This experiment implemented one embodiment of the present invention on the fluidized catalytic cracking process unit for a period of three days during which NO oxidation, overall NOₓ removal, sodium chlorite flow rate, and deionized water flow rate were monitored and recorded. The NO oxidation and NOₓ removal is reported as a percentage which is defined for uses herein as the [(inlet concentration—the outlet concentration)/inlet concentration]*100. This data is reported below in Table 2 below.

TABLE 2

| | Water Flow | NaClO₂ flow | NO oxidation | NOx removal |
|---|---|---|---|---|
| Day | (gpm) | (gpm) | % | % |
| 1 | 80-90 | 0 | 0 | 0 |
| | 90 | 1 | 42 | 15 |
| | 200 | 2.3 | 94 | 49 |
| | 300 | 2.3 | 99 | 57 |
| | 0 | 0 | 0 | 0 |
| | 465 | 2 | 99 | 55 |
| 2 | 465 | 2 | 99 | 46 |
| | 465 | 1.8 | 99 | 44 |
| | 465 | 1.5 | 99 | 42 |
| | 465 | 1.25 | 99 | 40 |
| | 465 | 1.1 | 99 | 39 |
| | 465 | 0.7 | 93 | 39 |
| | 465 | 0 | 0 | 0 |
| 3 | 170 | 1 | 51 | 9 |
| | 170 | 1.8 | 63 | 13 |
| | 170 | 2 | 67 | 13 |
| | 170 | 2.3 | 76 | 15 |
| | 350 | 2.3 | 98 | 32 |
| | 465 | 2.2 | 97 | 45 |
| | 350 | 1.8 | 99 | 44 |
| | 350 | 1 | 97 | 38 |

The maximum water flow rate associated with the spray nozzles of the separator drum utilized in this experiment was 465 gpm. Thus, it is believed, based on the collected data, that by utilizing spray nozzles with a higher flow rate capacity, or modifying the spray nozzles used herein in a manner such that their flow rate capacity is increased, the NOₓ removal rate would increase.

Also, it is believed, that by increasing the gas/liquid contact area, the NOₓ removal rate will also increase. Packing material used in this experiment and it was limited to 5 ft of the separator drum. It would be advantageous to increase the gas/liquid contact area by, for example, increasing the volume of packing material or by utilizing a packing material that would provide for an increased gas/liquid contact area.

1. A process for reducing NOₓ concentrations in waste gas streams, which streams contain both NOₓ and SOₓ species, which process comprises:
a) removing at least a fraction of the SOₓ species from said waste gas stream thereby producing a SOₓ depleted waste gas stream;
b) contacting said SOₓ depleted waste gas stream with an effective amount of sodium chlorite at conditions that will oxidize at least a fraction of oxidizable NOₓ species to higher nitrogen oxides; and
c) removing at least a fraction of said higher nitrogen oxides.

2. The process according to claim 1 wherein said waste gas stream is from a fluidized catalytic cracking process unit.

3. The process according to claim 2 wherein step a) above is carried out by a wet desulfurization processes such as water scrubbing, alkali scrubbing, magnesia scrubbing, ammonium scrubbing.

4. The process according to claim 2 wherein step a) above is carried out by a dry desulfurization process using an agent selected from manganese oxide and activated carbon.

5. The process according to claim 3 wherein said SOₓ species are removed by wet gas scrubbing.

6. The process according to claim 5 wherein said sodium chlorite is contacted with said waste gas stream at a point downstream from the wet gas scrubber of a combustion unit.

7. The process according to claim 5 wherein said sodium chlorite is contacted with said waste gas stream in a separation drum associated with a wet gas scrubbing unit.

8. The process according to claim 5 wherein said sodium chlorite is contacted with said waste gas stream in a separation drum of a wet gas scrubbing unit through at least one spray nozzle.

9. The process according to claim 1 wherein said sodium chlorite is mixed with water before contacting said waste gas stream.

10. The process according to claim 9 wherein said sodium chlorite is mixed with deionized water before contacting said waste gas stream.

11. The process according to claim 1 wherein at least a fraction of said higher nitrogen oxides is removed by a method selected from alkaline solution absorption, reducing solution absorption, scrubbing, ammonia injection, absorption with water, and catalytic conversion.

12. The process according to claim 11 wherein at least a fraction of the higher nitrogen oxides is removed by use of an alkaline solution comprised of an aqueous caustic soda solution.

13. The process according to claim 11 wherein at least a fraction of the higher nitrogen oxides is removed by use of a reducing solution such as an aqueous sodium thiosulfate solution.

14. The process according to claim 11 wherein at least a fraction of the higher nitrogen oxides is removed by ammonia injection wherein the ammonia is injected in admixture with hydrogen.

15. The process according to claim 11 wherein at least a fraction of the higher nitrogen oxides is removed by absorption with water.

16. The process according to claim 10 wherein an amount of deionized water sufficient to absorb at least a fraction of said higher oxides is injected with said sodium chlorite.

17. The process according to claim 3 wherein at least a fraction of NOₓ species initially present in said waste gas stream are removed before said step a) of claim 1 above.

18. A process for reducing the NOₓ concentration in a waste gas stream which contains both SOₓ and NOₓ species, which process comprises:
a) removing at least a fraction of the SOₓ species present in said waste gas stream thereby producing a SOₓ depleted waste gas stream;
b) contacting the SOₓ depleted waste gas stream with an effective amount of sodium chlorite at conditions effective to oxidize at least a fraction of the oxidizable NOₓ species present in said SOₓ depleted waste gas stream; and
c) removing at least a fraction of the resulting higher nitrogen oxides by a method selected from alkaline solution absorption, reducing solution absorption, scrubbing, ammonia injection, catalytic conversion, and absorption with water.

19. The process according to claim 17 wherein said waste gas stream is generated by a fluidized catalytic cracking unit.
